(19) United States
(12) Patent Application Publication
(10) Pub. No.: US 2024/0425090 A1
(43) Pub. Date: Dec. 26, 2024

(54) TANKER RAILROAD CAR HAVING NON-CONTACT VOLUME SENSING ASSEMBLY

(71) Applicant: Gunderson LLC, Lake Oswego, OR (US)

(72) Inventors: Michael Williams, St. Louis, MO (US); James T. Chambers, Keller, TX (US)

(21) Appl. No.: 18/743,650

(22) Filed: Jun. 14, 2024

Related U.S. Application Data
(60) Provisional application No. 63/510,181, filed on Jun. 26, 2023.

(51) Int. Cl. B61D 49/00; B61D 5/06; F16K 27/07; F16K 31/60

(52) U.S. Cl. CPC B61D 49/00; B61D 5/06; F16K 27/07; F16K 31/602

(57) ABSTRACT

A tanker railroad car with one or more non-contact sensing assemblies that are configured to sense a level of fluid in a tanker railroad car using one or more non-contact sensors, wherein the non-contact sensing assemblies are configured to communicate with a converter device that translates output signals from the non-contact sensors into readings of the level of fluid in the tanker railroad car in desired output units.

### PRIORITY CLAIM

This patent application claims priority to and the benefit of U.S. Provisional Patent Application No. 63/510,181, filed Jun. 26, 2023, the entire contents of which are incorporated herein by reference.

### BACKGROUND

The railroad industry employs a variety of different railroad cars for transporting different products. For example, various known railroad cars that are configured to carry fluids are often called “tanker railroad cars” or simply “tank cars.”

Various known tank cars include a mechanical device configured to facilitate a determination of an amount of fluid in the tank car. Certain known tank cars include a magnetic gauging device configured to measure the fluid level within the tank of the tank car. Such magnetic gauging devices are used at the time of loading of fluid in the tank car to know how much fluid is inside the tank of the tank car. Such magnetic gauging devices are also used at the time of unloading to know how much fluid can be or has been removed from the tank of the tank car. Such magnetic gauging devices often include a float, a guide tube, a gauge rod, and a closure. The float and guide tube are located inside the tank. The closure is outside the tank and sealed to a fittings base plate within a top unloading housing of the tank. The float is a sealed spherical ball that houses an annular magnet. The guide tube is a long straight tube extending from the base plate down to the lowest level in the tank that is to be measured. The guide tube is filled with antifreeze and sealed at the bottom to prevent the fluid in the tank from entering the guide tube. The guide tube houses a gauge rod that extends up into the closure. The gauge rod is calibrated with marks indicating the depth of fluid in the tank. A magnetically conductive ring is at the base of the gauge rod. When the cap is removed from the closure, the gauge rod rises until the conductive ring “connects” to the magnet in the float. The gauge can then be manually read. The reading is converted to the desired units such as gallons or pounds to determine the volume of fluid in the tank. This magnetic gauging device thus has multiple mechanical components within the tank that are subject to failure. This gauging device also relies on a person to physically read the gauge and thus perform at least part of the measurement (including to correctly interpret the gauge rod reading). This gauging device also needs to be changed for different fluids transported in the tank of a tank car because different fluids have different densities.

There is a continuing need to provide tank cars that address these issues including tank cars with such mechanical gauging devices with multiple components that are subject to failure.

### SUMMARY

Various embodiments of the present disclosure provide a tanker railroad car having a non-contact volume sensing assembly. In various embodiments, the non-contact volume sensing assembly includes a sensor configured to measure the time of travel of a pulse (such as but not limited to a sound or light pulse) from the sensor to an upper surface of the fluid and back to the sensor. In various embodiments, the sensor outputs this time of travel as an amperage of an electrical signal. In various embodiments, the amperage of the electrical signal can be converted to units such as outage distance, gallons, or pounds of fluid to determine the volume of fluid in the tank of the tank car. In various embodiments, the non-contact volume sensing assembly includes a wire that can be connected to a computing device configured to receive the electrical signal from the sensor. In various embodiments, the non-contact volume sensing assembly includes a shield or shielding device (such as but not limited to a ball valve) that protects the sensor from the fluid in the tank of the railroad car such as when the railroad car is moving and at other times when the sensor is not being employed.

In various embodiments, the non-contact volume sensing assembly eliminates the need for the floats, guide tubes, brackets, and gauge rods of the magnetic gauging devices as described above. In various embodiments, by eliminating the mechanical components of a magnetic gauging device, the non-contact volume sensing assembly eliminates the potential failures of the ball, magnets, guide tube, guide bracket, and gauge rod.

In various embodiments, the non-contact volume sensing assembly can include or be connected to an interface that enables the assembly to be reprogrammed when the fluid in the tank car changes thus eliminating the need for separate gauge rods for each different fluid in the tank car.

In various embodiments, the non-contact volume sensing assembly includes a wireless transmitter for transmitting signals from the sensor. In various such wireless embodiments, an operator does not have to be on top of the tank car to read the non-contact volume sensing assembly.

In various embodiments, the non-contact volume sensing assembly is more ergonomic in that the operator does not have to physically read a gauge rod but rather the operator simply has to record the reading.

In various embodiments, the non-contact volume sensing assembly can retain a data record of tank levels and dates.

Other objects, features, and advantages of the present disclosure will be apparent from the following detailed disclosure, taken in conjunction with the accompanying sheets of drawings, wherein like reference numerals refer to like parts.

### BRIEF DESCRIPTION OF THE FIGURES

FIG. 1 is a top perspective view of a tanker railroad car of one example embodiment of the present disclosure, shown without the trucks and wheels of the tanker railroad car.

FIG. 2 is a top cross-sectional perspective view of the tanker railroad car of FIG. 1, shown without the trucks and wheels of the tanker railroad car.

FIG. 3 is an enlarged fragmentary perspective view of part of the top portion of the tanker railroad car of FIG. 1, showing the non-contact volume sensing assembly connected to a fittings plate of the tank of the tanker railroad car in accordance with one example embodiment of the present disclosure.

FIG. 4 is an enlarged perspective view of the non-contact volume sensing assembly of FIG. 3 shown removed from the fittings plate of the tank of the tanker railroad car of FIG. 1.

FIG. 5 is an enlarged partially exploded perspective view of the non-contact volume sensing assembly of FIG. 3 shown removed from the fittings plate of the tank of the tanker railroad car of FIG. 1.

FIG. 6 is an enlarged cross-sectional view of the non-contact volume sensing assembly of FIG. 3 shown connected to a part of the fittings plate of the tank of the tanker railroad car of FIG. 1, and showing the ball valve thereof in an open position.

FIG. 6A is an enlarged cross-sectional view of the non-contact volume sensing assembly of FIG. 3 shown connected to a part of the fittings plate of the tank of the tanker railroad car of FIG. 1, and showing the ball valve thereof in a closed position protecting the sensor.

FIG. 7 is a block diagram of certain electronic components of the non-contact sensing assembly of one example embodiment of the present disclosure.

FIG. 8 is a top perspective view of the non-contact sensing assembly equipped with a protective cover that encloses the sensor wiring cable and connector in accordance with another example embodiment of the present disclosure.

FIG. 9 is a top perspective view of the non-contact sensing assembly of FIG. 8, shown without the protective cover.

FIG. 10 is a top perspective view of the non-contact sensing assembly of FIG. 8, showing the protective cover removed.

### DETAILED DESCRIPTION

While the features, devices, and apparatus described herein may be embodied in various forms, the drawings show, and the specification describes certain exemplary and non-limiting embodiments. Not all of the components shown in the drawings and described in the specification may be required, and certain implementations may include additional, different, or fewer components. Variations in the arrangement and type of the components; the shapes, sizes, and materials of the components; and the manners of connections of the components may be made without departing from the spirit or scope of the claims. Unless otherwise indicated, any directions referred to in the specification reflect the orientations of the components shown in the corresponding drawings and do not limit the scope of the present disclosure. Further, terms that refer to mounting methods, such as coupled, mounted, connected, and the like, are not intended to be limited to direct mounting methods but should be interpreted broadly to include indirect and operably coupled, mounted, connected and like mounting methods. This specification is intended to be taken as a whole and interpreted in accordance with the principles of the present disclosure and as understood by one of ordinary skill in the art.

Various embodiments of the present disclosure relate to a tanker railroad car with a non-contact volume sensing assembly. Various embodiments of the present disclosure relate to a non-contact volume sensing assembly for a tanker railroad car. Various embodiments of the present disclosure relate to a method of operating a tanker railroad car with a non-contact volume sensing assembly. Various embodiments of the present disclosure relate to a method of operating a non-contact volume sensing assembly in conjunction with a tanker railroad car.

In various embodiments, at each of various points in time during the operation of the tanker car, the non-contact sensing assembly is configured to provide one or more signals based on a determination of the volume of space above the fluid in the tank of the tank car at that point in time to facilitate the determination of the volume of the fluid in the tank of the tanker car at that point in time.

For purposes of description of the components of the illustrated example tank car described herein, the longitudinal direction is generally used to describe a direction of travel of or the length of the tank car, and the transverse direction is generally used to describe a direction lateral or perpendicular to the direction of travel of the tank car.

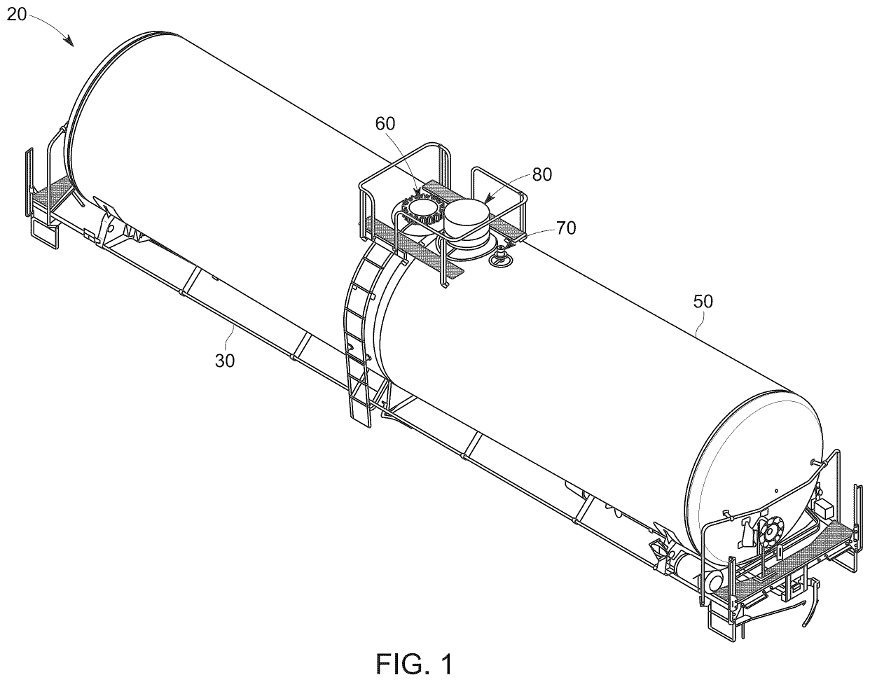

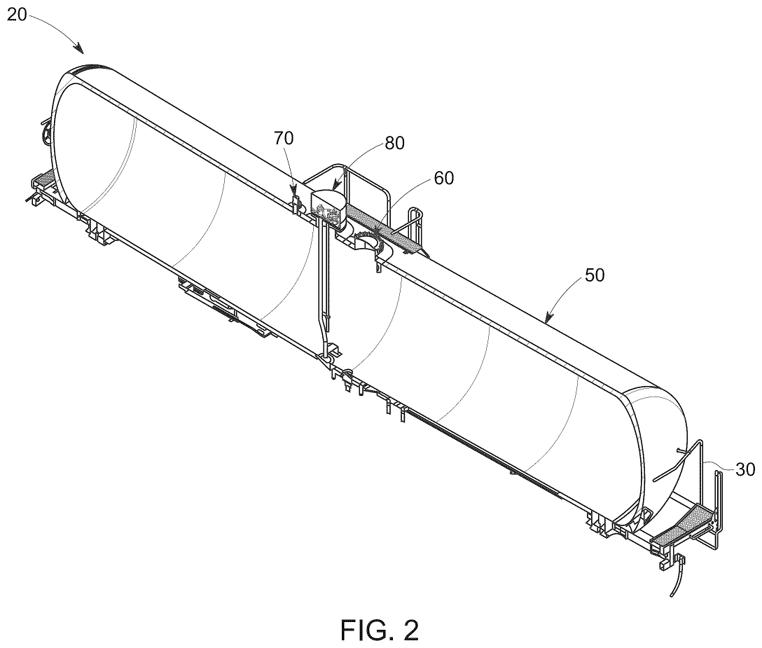

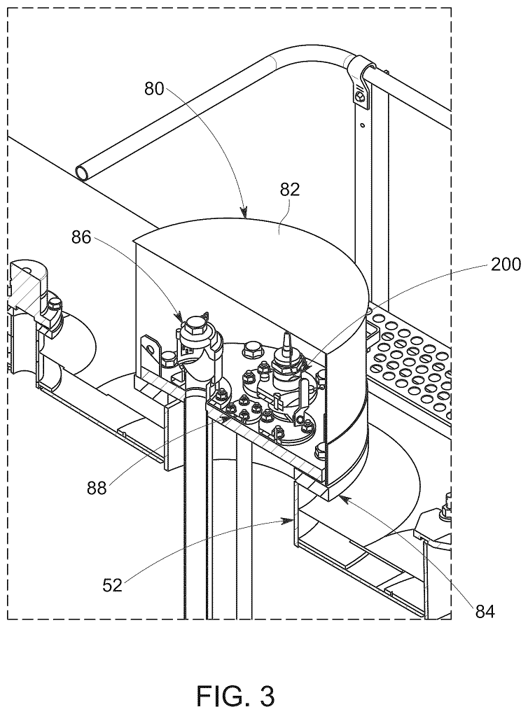

Referring now to the drawings, FIGS. 1, 2, 3, 4, and 5 illustrate certain components of a tanker railroad car 20 of an example embodiment of the present disclosure. This tank car 20 includes: (1) a frame 30; (2) spaced apart trucks (not shown) configured to support the frame 30; (3) a plurality of sets of wheel assemblies (not shown) that respectively support the trucks; and (4) a fluid holding cargo tank 50 connected to and supported by the frame 30 (and referred to as a “tank” herein for brevity).

The tank car 20 includes a manway 60 connected to the top of the tank 50, a pressure relief device 70 connected to the top of the tank 50, and a fitting assembly 80 connected to the top of the tank 50. In various embodiments, the tank car 20 is a non-pressure general service car.

In this example embodiment, the fitting assembly 80 includes a fitting assembly housing cover 82, a fittings plate 84, an eduction ball valve 86, a blind flange 88, and a non-contact sensing assembly 200. The eduction ball valve 86, the blind flange 88, and the non-contact sensing assembly 200 are mounted atop the fittings plate 84. The fitting assembly housing cover 82, which covers and protects the components of the fitting assembly 80 including the non-contact sensing assembly 200, is also mounted to the fittings plate 84. The non-contact sensing assembly 200 or components of the non-contact sensing assembly 200 can be certified to class 1 division 2 per ANSI/ISA-12.12.01-2015. The fitting assembly 80 is mounted atop the tank 50 at the location of a fitting nozzle tank opening 52. The fitting nozzle tank opening 52 provides an aperture into the tank 50 so that the non-contact sensing assembly 200 positioned in that opening 52 has a “line of sight” to the fluid in the tank 50.

Except for the non-contact sensing assembly 200, the components of the tank car 20 can be any suitable currently known tank car components or any future developed tank car components and are thus not described herein for brevity. Additionally, the components, size, shape, and configuration of the tank car 20 can also vary in accordance with the present disclosure.

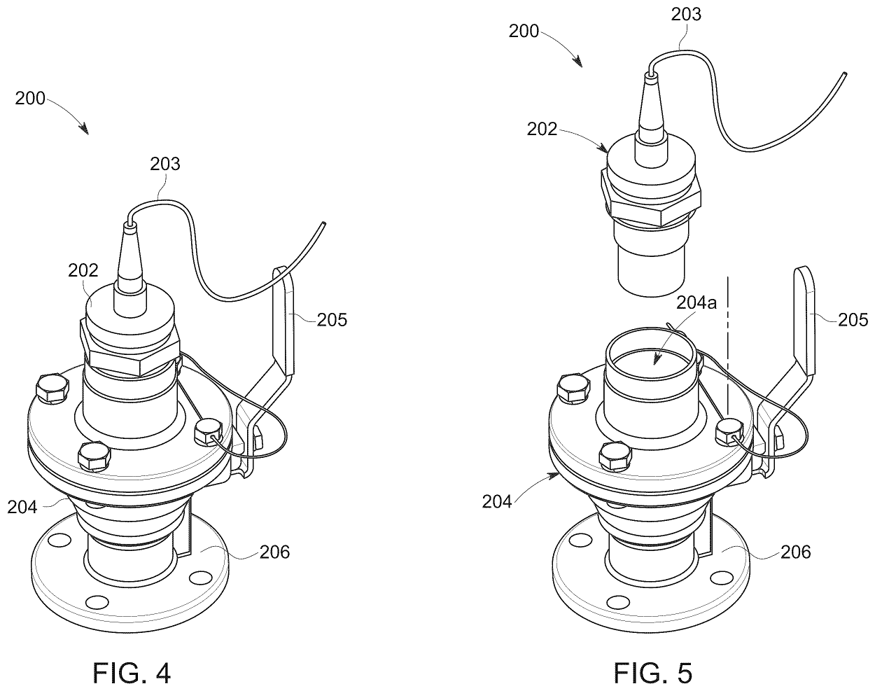

As best shown in FIGS. 4, 5, 6, and 6A, the illustrated example non-contact sensing assembly 200 includes: (1) a non-contact sensor 202 connected to a communication electrical cable 203; and (2) shield such as a ball valve 204 including a connection flange 206. The non-contact sensor 202 is mounted to the top of the ball valve 204 via threading (not shown) or another suitable attachment mechanism, and is positioned in a top opening 204a defined by the ball valve 204. The non-contact sensing assembly 200 is mounted to the top of the fittings plate 84 via the connection flange 206 using suitable fasteners (not shown). In various other embodiments, the non-contact sensing assembly 200 can be mounted to the top of the tank car 20 using another suitable attachment mechanism and/or fasteners.

The non-contact sensing assembly 200 is non-contact in the sense that it does not need to make physical contact with the fluid in the tank 50 of the tank car 20 to facilitate a determination of the amount of fluid in the tank 50 at any one point in time. Instead, the fluid in the tank 50 of the tank car 20 is accessible to the non-contact sensor 202 through the fitting nozzle tank opening 52 so that the non-contact sensor 202 can utilize a pulse (such as a sound or light pulse) to determine or enable determination of the amount of fluid in the tank 50 by determining the amount of space above the fluid in the tank and thus the level of the fluid in the tank 50 at that point in time.

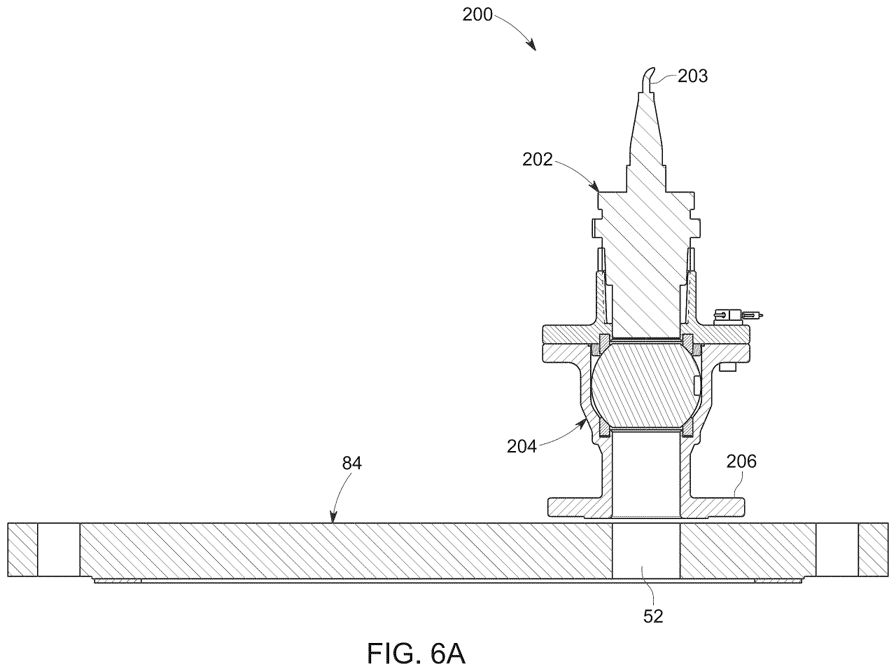

In various embodiments, the non-contact sensor 202 is shielded from the fluid in the tank 50 by a suitable shield or shielding device such as by the example illustrated ball valve 204. The ball valve 204 can selectively act as a cover for the non-contact sensor 202 so that the fluid in the tank 50 does not inadvertently contact the non-contact sensor 202, which can possibly contaminate the non-contact sensor 202 and possibly cause it to malfunction. Such inadvertent contact of the fluid in the tank 50 with the non-contact sensor 202 is possible during movement of the tank car 20, wherein the movement can cause the fluid in the tank to splash. It should be appreciated that the ball valve 204 is: (1) movable from an open position such as shown in FIGS. 4, 5, and 6, to a closed position such as shown in FIG. 6A; and (2) is partly positioned between the sensor and the opening in the tank. It should also be appreciated that the sensor is spaced from the opening in the tank and thus further protected from the fluid—while still having access to the fluid when needed. It should further be appreciated that this configuration protects the senor from fluids that can be transported in the tanks and that can adversely affect the sensor (such as but not limited to: (1) Anhydrous Ammonia; (2) Carbon Dioxide; (3) Chlorine; (4) Ethylene Oxide; (5) a Liquefied Hydrocarbon Gas Mixture; (6) Liquefied Petroleum Gas; (7) Sulfur Dioxide; and (8) Vinyl Chloride).

In various embodiment, the shield or shielding device is movable from an open position to a closed position by an operator via a mechanism (such as a lever) connected thereto. In various embodiments, the mechanism is operatable by a person on top of the tanker car. In various embodiments, the mechanism can be operated remotely (and in such embodiments can includes a remotely controlled actuator.

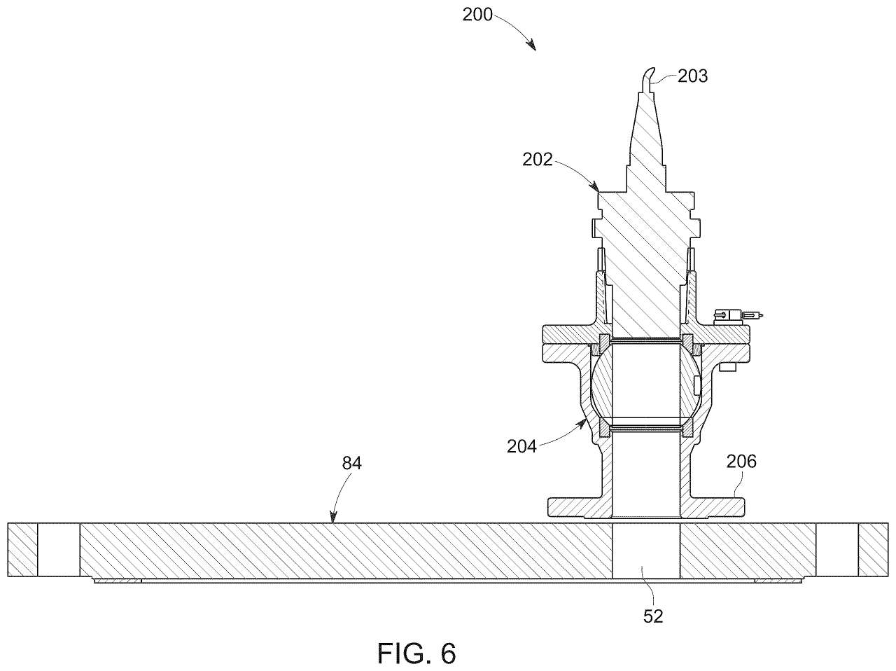

In this illustrated embodiment, a lever 205 of the ball valve 204 is shown in an open position in FIGS. 4 and 5 such that the fluid in the tank 50 is accessible to the non-contact sensor 202 through the fitting nozzle tank opening 52. When the lever 205 of the ball valve 204 is in an open position, the ball valve 204 does not block the non-contact sensor 202 from having access to the fluid in the tank 50 through the fitting nozzle tank opening 52. When in the open position, the ball valve 204 enables the non-contact sensor 202 to send pulses into the tank 50. When the lever 205 of the ball valve 204 is in a closed position, the ball valve 204 blocks the non-contact sensor 202 from having access to the fluid in the tank 50 through the fitting nozzle tank opening 52. When in the closed position, the ball valve 204 protects the non-contact sensor 202 during transit and until such time lever 205 is moved to the open position to enable a gauge level reading to be performed.

The ball valve 204 functions as the primary closure to the tank 50, and also enables the non-contact sensor 202 to be easily removed and replaced as needed, such as while the tank car 20 is in the field. The costs of transportation, cleaning, and replacement of the ball-type magnetic gauging devices (such as described above) can thus be avoided through use of the non-contact sensing assembly 200 of the present disclosure.

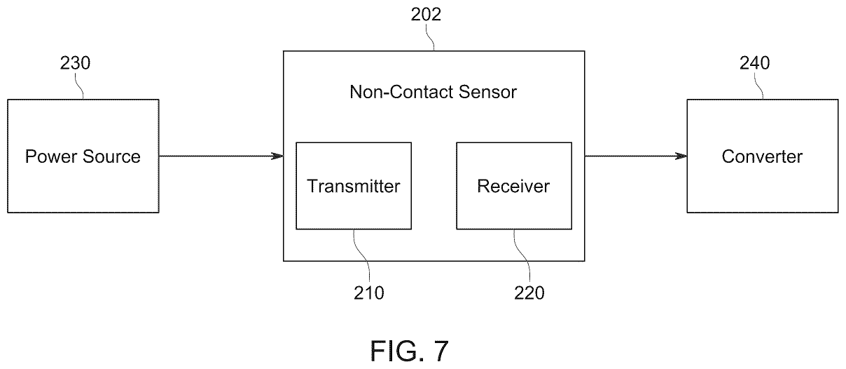

This example non-contact sensing assembly 200 includes an ultrasonic sensor in this example embodiment. As shown in FIG. 7, the non-contact sensor 202 includes a transmitter 210 configured to emit one or more ultrasonic sound pulses downwardly toward the fluid in the tank 50 such that such pulses can reflect off the top surface of the fluid in the tank 50 and back towards a receiver 220 of the non-contact sensor 202. The time that each of the ultrasonic sound pulses takes to travel back to the non-contact sensor 202 is used to determine the level of fluid in the tank 50. In particular, the distance between the non-contact sensor 202 and the top surface of fluid in the tank 50 is calculated based on the speed of sound and the time that each of the ultrasonic sound pulses takes to travel back to the non-contact sensor 202. The calculated distance corresponds to the portion of the tank 50 that is currently empty (i.e., the distance between the non-contact sensor 202 and the top level of the fluid in the tank 50).

The non-contact sensor 202 is configured to generate an output signal corresponding to this calculated distance for each of one or more pulses. The output signal can be between 4-20 mA to denote the calculated distance, for example, or can be within other suitable amperage ranges.

The cable 203 is configured to convey the output signal(s) from the non-contact sensor 202 to a converter device 240 that can include a process controller or similar controller. The converter device 240 is configured to translate the output signal(s) into one or more readings in a desired output unit, such as outage distance (e.g., in inches), gallons, or pounds. The reading(s) in the desired output unit denotes the amount of fluid in the tank 50. For example, the converter device 240 can be configured to calculate the reading(s) in the desired output unit based on the output signal(s) from the non-contact sensor 202 and based on a suitable conversion equation and/or through the use of a look-up table or database.

In various embodiments, the converter device 240 includes a readable display device (not shown) for a user to view the reading(s) showing the amount of fluid in the tank 50.

In various embodiments, a separate electronic device (not shown) can communicate (via a wire or wirelessly) with the converter device 240 to show the reading(s).

In various embodiments, the converter device 240 is permanently connected to the non-contact sensor 202 via the cable 203.

In various embodiments, the converter device 240 is portable so that a user can bring the converter device 240 to the top of the tank car 20 and connect the converter device 240 to cable 203 via suitable wiring, connectors, and/or adapters. In various such embodiments, the converter device 240 can provide a power supply to the non-contact sensor 202 as further described below.

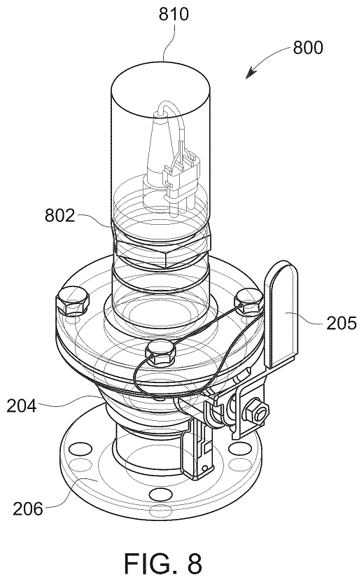

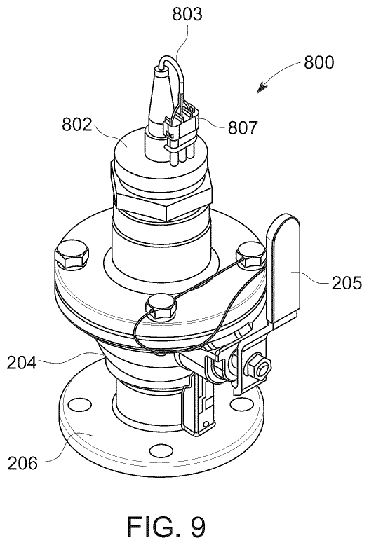

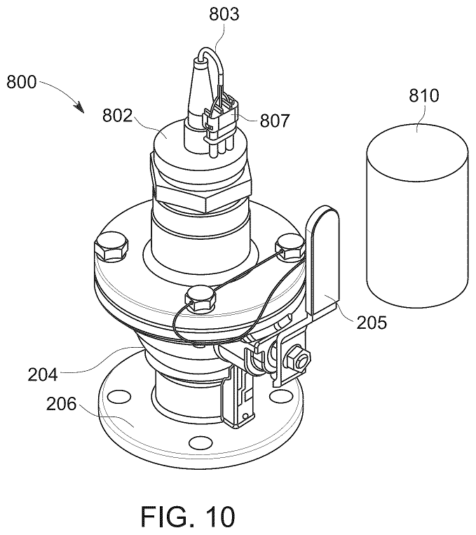

In another example embodiment shown in FIGS. 8, 9, and 10, a non-contact sensing assembly 800 includes a non-contact sensor 802 with a cable 803 terminating in a coupling 807. The coupling 807 is connectable to the converter device 240 using a suitable connector so that the contacts (not labeled) of the coupling 807 make an electrical connection with the corresponding contacts (not shown) of a connector (not shown) of the converter device 240. The coupling 807 can include suitable keying, orientation, and/or locking mechanisms (not shown) to ensure that the connection is correctly made between the coupling 807 and the connector of the converter device 240.

The non-contact sensing assembly 800 includes a removable protective cover or cap 810 that can enclose the cable 803 and coupling 807, such as by snapping or screwing onto the top portion (not labeled) of the non-contact sensor 802. The protective cover 810 protects the cable 803 and coupling 807 from damage and contamination when the non-contact sensor 802 is not in use. The non-contact sensing assembly 800 and/or particular components of the non-contact sensing assembly 800 can be certified to class 1 division 2 per ANSI/ISA-12.12.01-2015.

In various embodiments, the converter device 240 includes a memory device so that the past history of fluids in the tank 50 can be stored, including the date and time of each of the readings, the reading(s) in desired output units, and/or other pertinent data. In various such embodiments, the data can be downloaded from the converter device 240 to a suitable electronic device, database, server, etc. (all not shown).

In various embodiments, the converter device 240 is programmable and configurable to enable the measurement of different types of fluids with different properties, and/or for different physical characteristics of the tank 50 (e.g., sizes, diameters, slopes, pressures, etc.). In various embodiments, a user can access the settings for the converter device 240 using a separate electronic device (not shown) or using the converter device 240 itself. The settings for the converter device 240 can include the ability to configure the various parameters that can affect the measurement of the fluid in the tank 50.

In various embodiments, the converter device 240 is configured to automatically adapt to show the measurement of the amount of fluid in the tank 50 regardless of the type of fluid in the tank 50 and/or the different physical characteristics of the tank 50.

In various embodiments, the converter device 240 includes a wireless transmitter, receiver, and/or transceiver to enable a user to communicate with the converter device 240 remotely using a suitable electronic device (such as but not limited to a smartphone, tablet, laptop computer, etc.). For example, the user can be situated at ground level with the electronic device that remotely receives a reading of the level of the fluid in the tank 50 from the converter device 240. This can eliminate the need for the user to physically be at the top of the tank car 20. In various such embodiments, the converter device 240 can be configured to enable the user to remotely configure and set up the converter device 240 through the use of wireless communication. In various such embodiments, the non-contact sensing assembly can include a suitable actuation device (not shown) that automatically operates the lever 205 to open and close the shielding device such as the ball valve. In other embodiments, the actuation device is directly connected to the shielding device such as the ball valve.

In various embodiments, the non-contact sensor 202 is powered by a suitable power source 230, such as a low voltage battery (e.g., 5, 12, or 24 V) that can be rechargeable or non-rechargeable.

In various embodiments, the power source 230 is wired to the non-contact sensor 202 so that it is continuously powered by the power source 230.

In various embodiments, a coupling (not shown) can be used to connect and disconnect the power source 230 to the non-contact sensor 202.

In various embodiments, the power source 230 can be part of the converter device 240. The non-contact sensor 202 is powered in these embodiments when the converter device 240 is connected to the cable 203 so that the power source 230 of the converter device 240 supplies power to the non-contact sensor 202.

In various embodiments, the power source 230 for the non-contact sensor 202 is powered by a solar panel (not shown) mounted on the tank car 20.

In various embodiments, the non-contact sensor 202 includes an LPU-2428 ultrasonic sensor from Automation Products Group Inc. of Logan, Utah.

In various such embodiments, the cable 203 of the sensor can have a strain relief mechanism 704 to minimize damage to the cable 203 and the sensor during handling of the cable 203.

In various embodiments, the non-contact sensor 202 can be of another suitable type, such as a differential pressure based sensor, a tuning fork based sensor, a guided wave radar based sensor, or a laser based sensor.

For example, in various embodiments, the non-contact volume sensing assembly includes a sensor configured to emit one or more signals in the form of radar waves that are directed downwardly toward and to contact the upper surface of the fluid in the tank, and are be reflected back by the fluid to the sensor. In various such embodiments, the waves arriving back at the sensor provide information about the location of upper surface of the fluid in the tank.

In various embodiments, the non-contact sensing assembly 200 mounted on the tank 50 includes multiple non-contact sensors 202. In various embodiments, the multiple non-contact sensors 202 are each of a same type of sensor. In various embodiments, the multiple non-contact sensors 202 are each of two or more different types of sensors. In various such embodiments, the level of the fluid in the tank 50 can be measured by one or more of the non-contact sensors 202. In various such embodiments, the converter device 240 can communicate with and show readings from each of the non-contact sensors 202 to the user. In various such embodiments, the converter device 240 can calculate an average of all of the readings from the non-contact sensors 202 for increased accuracy. In various other embodiments, one of the non-contact sensors 202 can be a primary sensor and the other non-contact sensors 202 can be a backup or auxiliary sensor that can be utilized in case of failure of the primary sensor (such as due to defect, contamination, etc.).

In various embodiment, the tank car 20 includes multiple non-contact sensing assemblies 200 mounted on the tank 50, each of which can include one or more non-contact sensors 202. In various such embodiments, the level of the fluid in the tank 50 can be measured by one or more of the non-contact sensing assemblies 200. In various such embodiments, one or more converter devices 240 can communicate with and show readings to the user from the non-contact sensors 202 of the multiple non-contact sensing assemblies 200. In various such embodiments, the converter device 240 can calculate an average of all of the readings from the non-contact sensors 202 of the multiple non-contact sensing assemblies 200 for increased accuracy. In various other embodiments, one of the non-contact sensing assemblies 200 can be a primary assembly and the other non-contact sensing assemblies 200 can be a backup or auxiliary assembly.

In various embodiments, the non-contact sensing assembly is configured to determine the volume of other types of product in other types of railroad cars, such as hopper cars. Other types of product can include bulk material, such as grain, sand, clay, stone, coal, ore, etc.

In various embodiments, the non-contact sensing assembly can be mounted to a suitable bottom surface of a railroad car to measure the amount of product in a railroad car. For example, a non-contact sensor that is mounted to the bottom of a tank car can emit an ultrasonic sound pulse upwardly through fluid in a tank such that it can reflect off the interface between the fluid and the air and back towards the non-contact sensor. In various such embodiments, a bottom-mounted non-contact sensor can be mounted to the outside surface of the tank.

It will be understood that modifications and variations may be affected without departing from the scope of the novel concepts of the present invention, and it is understood that this application is to be limited only by the scope of the claims.

1. A railroad car comprising:
a frame;
a cargo tank supported by the frame; and
a fitting assembly connected to a top of the cargo tank, the fitting assembly including a non-contact sensing assembly, the non-contact sensing assembly including a non-contact sensor configured to transmit an ultrasonic pulse into the cargo tank and receive a reflected ultrasonic pulse back reflected by a top surface of fluid in the cargo tank to sense a level of the fluid in the cargo tank, and to generate an output signal based on the sensed level of the fluid in the cargo tank, the non-contact sensing assembly including a shield that is positioned to protect the non-contact sensor from the fluid in the cargo tank when the railroad car moves.

2. The railroad car of claim 1, wherein the shield includes a closeable ball valve.

3. The railroad car of claim 1, wherein the shield includes a closeable ball valve, wherein the non-contact sensor is positioned above at least part of the shield.

4. The railroad car of claim 3, wherein the non-contact sensor is connected to a top of the closable ball valve.

5. The railroad car of claim 4, wherein the non-contact sensing assembly includes a lever coupled to the closeable ball valve.

6. The railroad car of claim 3, wherein the non-contact sensing assembly includes a lever coupled to the closeable ball valve.

7. The railroad car of claim 1, wherein the non-contact sensing assembly includes a lever coupled to the shield.

8. The railroad car of claim 7, wherein the shield is movable by the lever from a non-contact sensor protecting position to a non-contact sensor access position.

9. The railroad car of claim 1, wherein the shield is movable from a non-contact sensor protecting position to a non-contact sensor access position.

10. The railroad car of claim 9, wherein the non-contact sensing assembly includes a lever coupled to the shield.

11. The railroad car of claim 1, wherein the non-contact sensing assembly includes a lever operable to cause the non-contact sensor to be shielded from fluid in the cargo tank.

12. The railroad car of claim 1, which includes a power source connected with the non-contact sensor to power the non-contact sensor.

13. The railroad car of claim 1, wherein the non-contact sensing assembly is connectable to a converter device configured to receive and convert the output signal into a desired output unit.

14. The railroad car of claim 1, wherein the non-contact sensing assembly is connectable to:
a power source to power the non-contact sensor; and
a converter device configured to receive and convert the output signal into a desired output unit.

15. The railroad car of claim 14, wherein the power source is part of the converter device.

16. The railroad car of claim 1, wherein the non-contact sensor is configured to transmit a radar wave into the cargo tank toward the fluid in the cargo tank, to receive a reflected radar wave, and to generate an output signal based on a sensed level of the fluid in the cargo tank based on the received reflected radar wave.
